(19) United States
(12) Patent Application Publication
(10) Pub. No.: US 2015/0320214 A1
(43) Pub. Date: Nov. 12, 2015

(54) TABLE ACCESSORY

(71) Applicant: David deRoy VanZuydewyn, Surrey (CA)

(72) Inventor: David deRoy VanZuydewyn, Surrey (CA)

(21) Appl. No.: 14/270,520

(22) Filed: May 6, 2014

(51) Int. Cl. A47B 97/00; F16M 13/02

(52) U.S. Cl. CPC A47B 97/00; F16M 13/022

(57) ABSTRACT

Disclosed are table accessories comprising: a first vertical beam at a first end and a second vertical beam at a second end; at least one first angled beam rotatably connected to the first vertical beam; at least one second angled beam rotatably connected to the second vertical beam; and a horizontal beam rotatably connected to both the first and the second angled beams.

### FIELD OF THE INVENTION

The present invention is in the field of outdoor equipments, and in particular, in the field of accessories for a table.

### BACKGROUND OF THE DISCLOSURE

Going on a picnic in a park for a holiday, going to a tailgate party before a sporting event, or going to a cottage near a lake for a couple of days, or a week, and spending evenings around the picnic table with family and friends is a popular practice. During these events, when one typically uses a propane lantern to provide light at the table, the ambience is ruined by the glaring light from the lantern not to mention the loss of some valuable space on the table for the lantern to sit. A typical family, with their smartphones, tablets, wireless speakers, and not to mention parents trying to find space on the table for the other traditional camping paraphernalia such as condiments, plates, chip bowls, paper towel, etc., quickly run out of space on the table. A group of young, hard-working, outdoorsy, beer-drinking adults camping out for a long weekend discover that no one brought a bottle opener to the party. In addition, some revelers display either the national flag or the flag of their sports team. However, picnic tables are not equipped for a prominent display of the flag.

Therefore, there is a need for a space-saving device to be used on a table. Preferably, the space-saving device would allow the users to decorate the table as they desire.

### SUMMARY OF THE INVENTION

Disclosed are table accessories comprising: a first vertical beam at a first end and a second vertical beam at a second end; at least one first angled beam rotatably connected to the first vertical beam; at least one second angled beam rotatably connected to the second vertical beam; and a horizontal beam rotatably connected to both the first and the second angled beams.

### BRIEF DESCRIPTION OF THE DRAWINGS

FIG. 1 is a drawing showing an embodiment of the disclosed accessory.

FIG. 2 is a drawing showing an embodiment of a flag holder.

FIG. 3 is a drawing showing an embodiment of a car-flag adaptor and an embodiment of a tightener.

### DETAILED DESCRIPTION OF THE EMBODIMENTS

Disclosed herein are devices that connect to a table and provide a place other than the tabletop for the user to place condiments, utensils, napkins, lights, or electronic devices, or to personalize and decorate the table, for example for a holiday. The table accessory disclosed herein is configured to attach to any table with minimal effort. It spans the length of the table, which provides a convenient access to the accessory from any seat around the table.

The disclosed table accessories are now discussed in view of the disclosed drawings.

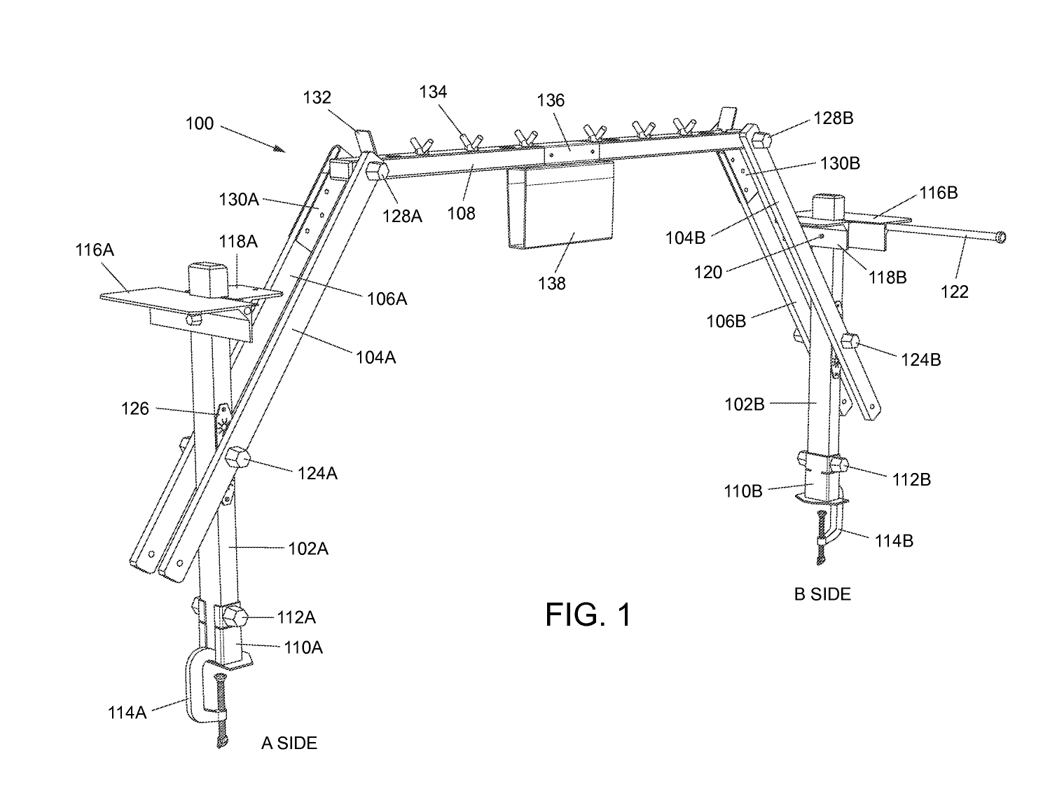

FIG. 1 shows an embodiment of the disclosed table accessory 100 in its fully extended position. This particular embodiment of the accessory 100 comprises two vertical beams 102, for angled beams 104,106, and one horizontal beam 108. In some embodiments, the accessory 100 does not comprise the angled beams 104,106 and the horizontal beam 108 connects directly to the vertical beams 102. In other embodiments, the accessory 100 does not comprise the vertical beams 102 and the horizontal beam 108 connects directly to the angled beams 104,106, which in turn connect to the table. In further embodiments, the accessory 100 does not comprise the horizontal beam 108 and the angled beams 104,106 connect to each other in the middle. In still other embodiments, the accessory 100 only comprises the angled beams 104,106, which connect to each and to the table. In some of these embodiments, there is only one angled beam 104,106 at either side of the table, while in other embodiments, such as the one shown in FIG. 1, there are two angled beams 104,106 at each side of the table.

In some embodiments, for example that shown in FIG. 1, the vertical beam 102 and the horizontal beam 108 are sandwiched between the angled beams 104,106. In other embodiments, there is a single angled beam 104 and it is sandwiched between two parallel vertical beams at one end and two parallel horizontal beams at the other end.

The embodiment shown in FIG. 1 comprises two substantially symmetrical sides, referred to as “A SIDE” and “B SIDE.” Like elements on each side are distinguished by “A” or “B” indicators. For example vertical beam 102A is the vertical beam 102 on the A side, whereas vertical beam 102B is the vertical beam 102 on the B side.

Referring back to FIG. 1, each of the vertical beams 102 fits inside a bracket 110. In embodiments where another beam connects to the table, the connecting beam fits inside the bracket 110. In some embodiments, the vertical beam 102 is fastened to the bracket 110 using a screw and nut combination 112. In some embodiments, the nut of the combination 112 is embedded inside the bracket 110 (such as embedded nut or a threaded hole) such that the user needs to only tighten the screw of the combination 112. In other embodiments, the user needs to insert the screw through the holes in both the bracket 110 and the beam 102 and then insert the nut and tighten the screw and nut combination 112. In some embodiments, the bolts used to tighten the vertical beam 102 inside the bracket 110 are used in conjunction with a threaded insert from the opposing side to fasten the structure into position.

The bracket 110 is in turn affixed to the table with an affixing means, such as vice grips 114, as shown in FIG. 1, or a screw/nut combination (not shown), or a winged nut that tightens against the table (not shown), or any other means known in the art.

In some embodiments, the vertical beam 102 comprises a location to which at least one platform 116,118 is attached. In some embodiments, for example the one shown in FIG. 1, the platforms 116,118 are of different sizes, whereas in other embodiments, the platforms 116,118 are of the same size. In some embodiments, there is only one platform 116 or 118 on one side of the accessory 100. In other embodiments, there is only one platform 116 or 118 on either side of the accessory 100, for example 116A or 118A. In other embodiments, there is only one platform 116 or 118 on the A or B side of the accessory 100, but two platforms 116,118 on the other of the A or B side of the accessory 100. In other embodiments, for example the one shown in FIG. 1, there are two platforms 116,118 on both the A and B sides of the accessory 100. In still other embodiments, there are more than two platforms 116,118 on a single vertical beam 102. As shown in FIG. 1, the platforms 116 and 118 are connected at an angle 180° to each other. In the embodiments having more than two platforms, the additional platforms are connected, for example, at an angle of 90° to the other angles. In some embodiments, where there are only two platforms 116,118 on a single vertical beam 102, the platforms are connected at an angle of 90°.

In some embodiments, the vertical beam 102 comprises holes where the platforms 116,118 are to be connected. In these embodiments, each platform 116,118 comprises a small rod that can be placed inside of the hole on the vertical beam 102, thereby holding the platform 116,118 in place. In other embodiments, for example that shown in FIG. 1, a screw and nut combination 120 is used to hold the platforms 116,118 in place. In some of these embodiments, the screw of the combination 120 goes through one of the platforms 116,118, then through the vertical beam 102, then through the other of the platforms 116,118, and then the nut of the combination 120 is used to fasten the assembly together. In other embodiments, one or both of the platforms 116,118 comprise an embedded nut, for example a threaded hole, into which the screw of the combination 120 screws. Other methods of holding the platforms 116,118 in place known in the art are also contemplated.

In some embodiments, one or more of the platforms 116,118, for example platform 116B in FIG. 1, comprises a rod 122, which holds a roll of paper towel for convenient access.

In some embodiments, the vertical beam 102 comprises a groove into which a back ledge of the platform 116 or 118 is inserted. This allows for greater stability of the platforms 116,118.

In some embodiments, the platforms 116,118 comprise a plurality of holes arrayed around the perimeter, the middle, and/or on the vertical component, thereof to support hooks. The hooks allow objects, such as cooking utensils, to hang from the platforms 116,118. In some embodiments, a cord, such as a bungee cord, connects a platform on beam 102A with another platform on beam 102B, as, for example, a temporary clothes line to hang face cloths, wet fabrics, etc., to dry.

In some embodiments, to each vertical beam 102 are attached two angled beams 104,106. In these embodiments, the vertical beam 102 is sandwiched by the angled beams 104,106. A tightener 124 connects the angled beams 104,106 to the vertical beam 102. In some embodiments, the tightener 124 functions similarly to the screw/nut combination 112, discussed above. In other embodiments, the tightener 124 allows for a friction lock between the vertical beam 102 and the angled beams 104,106 such that when the tightener 124 is tightened, the angled beams 104,106 do not pivot, and are consequently stationary, around the pivot point of the tightener 124. Therefore, the user can loosen the tightener 124 and move the angled beams 104,106 to the desired angle, and then tighten the tightener 124 to hold the beams 104,106 in place with respect to the vertical beam 102.

In some embodiments, a metal plate 126 is placed on either side of each vertical beam 102, in close proximity to the pivot of the tightener 124. The metal plate 126 protects both the vertical beam 102 and the angled beams 104,106 from frictional wear as the beams 104,106 move with respect to the vertical beam 102. The metal plate 126 also provides additional strength to the location where the angled beams 104,106 are connected, which is the location where the weight of the rest of the accessory 100 rests on the vertical beam 102.

The horizontal beam 108 connects to the angled beams 104,106 at both ends by way of a tightener 128. The tightener 128 works in the same manner as the tightener 124, described above.

In some embodiments, the terminus of the angled beams 104,106 comprises a metal plate 130, for example as shown at the terminus of the angled beams 106A and 106B in FIG. 1. In other embodiments, for example as shown at the terminus of the angled beams 104A and 104B in FIG. 1, there is no metal plate 130 and the tightener 128 connects directly over the angled beams 104,106. The metal plate 130 provides for additional strength at the pivot point of the tightener 128 and also reduces the frictional wear at that point. The metal plate 130 also allows the user to use one hand to hold the horizontal beam 108 while the other hand tightens the angled beams 104,106 to the horizontal beam 108 using only one tightener 128.

In some embodiments, the horizontal beam 108 provides for the placement of decorative items on the accessory 100. In some embodiments, the horizontal beam 108 comprises holes where a car-flag adaptor 132 is placed. A car-flag is a flag, for example the flag of a country or a sports team, which can be flown from the window of a car. The base of the car-flag slides over the adaptor 132, which is then inserted in to a hole on the horizontal beam 108. In other embodiments, the horizontal beam 108 comprises holes where flag holders 134 are inserted.

In some embodiments, the horizontal beam 108 comprises a metal plate 136. The embodiment shown in FIG. 1 places the metal plate 136 at the center of the horizontal beam 108. In other embodiments, the metal plate 136 is long, i.e., longer than 1 foot, or alternatively covers more than half the length of the beam 108. In other embodiments, the metal plate 136 covers less than a third of the length of the beam 108. In other embodiments, the metal plate 136 runs the entire, or nearly the entire, span of the horizontal beam 108. In some embodiments, a logo, for example that of the manufacturer or the retailer of the accessory 100, is placed on the metal plate 136. In some embodiments, the metal plate 136 is attached to the horizontal beam 108 by two or more washers and screws (not shown) that sandwich the horizontal beam 108, washers, and the metal plate 136 together.

In some embodiments, the horizontal beam 108 comprises a second metal plate either in addition to, or in lieu of, the metal plate 136. While the metal plate 136 is located at the side of the horizontal beam 108, the second metal plate is placed underneath the horizontal beam 108. In some embodiments, the second metal plate is placed at the center of the horizontal beam 108. In other embodiments, the second metal plate is long, i.e., longer than 1 foot, or alternatively covers more than half the length of the beam 108. In other embodiments, the second metal plate covers less than a third of the length of the beam 108. In other embodiments, the second metal plate runs the entire, or nearly the entire, span of the horizontal beam 108.

In some embodiments, the second metal plate, located on the underside of the horizontal beam 108, has a small hole located where each flag-hole is located. This is intended to drain any water that is collected when it rains in order to prevent the horizontal beam 108 (if wood) to be soaked with rain water.

In some embodiments, a storage compartment 138 is attached to the horizontal beam 108. In some embodiments, the compartment 138 is a clear, see-through compartment, for example made out of plastic. In certain embodiments, the compartment 138 attaches to the metal plate 136 or to the second metal plate by the use of a magnet. In other embodiments, the compartment 138 screws onto the horizontal beam 108. In some embodiments, the compartment 138 is large enough to house an electronic tablet (e.g., an iPad®), or an MP3 device (e.g., an iPod®).

In some embodiments, a light, for example an LED light or a flash light, is attached to the horizontal beam 108. In certain embodiments, the light attaches to the metal plate 136 or the second metal plate by the use of a magnet. In other embodiments, the light screws onto the horizontal beam 108.

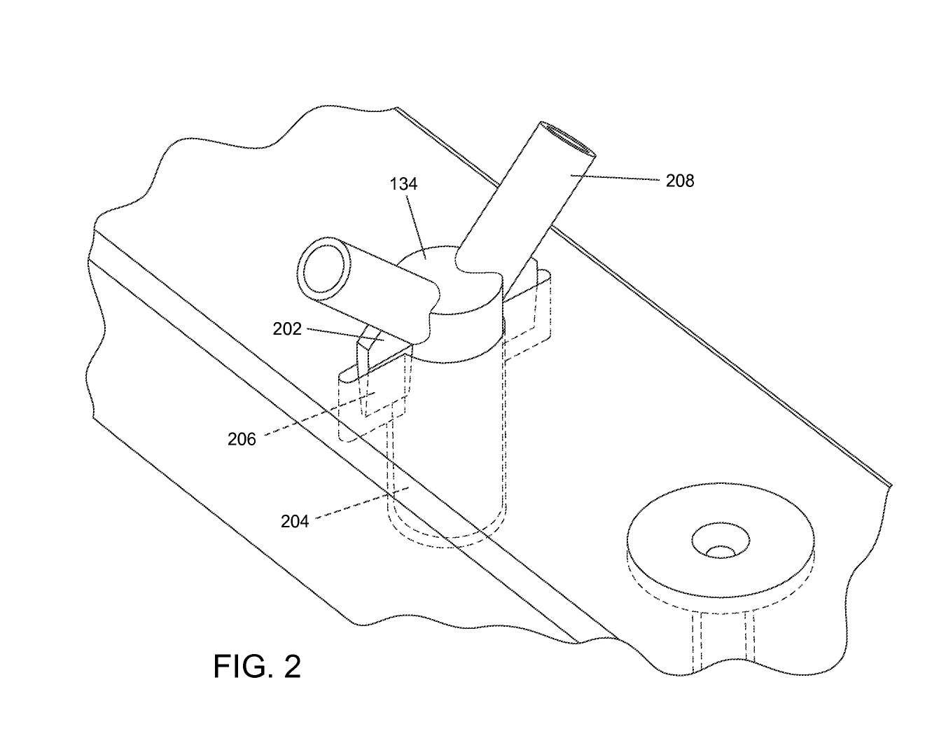

FIG. 2 shows a close-up view of the flag holder 134 placed in the horizontal beam 108. In some embodiments, the flag holder 134 comprises at least one wing 202. In some embodiments, the flag holder 134 comprises two or more wings 202. The flag holder 134 fits into a hole 204 on the beam 108. In some embodiments, the hole 204 comprises at least one slot 206, which matches the wing 202. When the flag holder 134 is placed inside of the hole 204, the wing 202 is inserted into the slot 206. The flag holder 134 is thereby prevented from rotating once it is inserted into the hole 204. The flag holder 134 comprises one or more tubes 208 into which a flag can be inserted.

In some embodiments, the hole 204 is an obround hole, which matches an obround base of the flag holder 134. This combination, similar to the use of wings 202, prevents the flag from twisting in the wind.

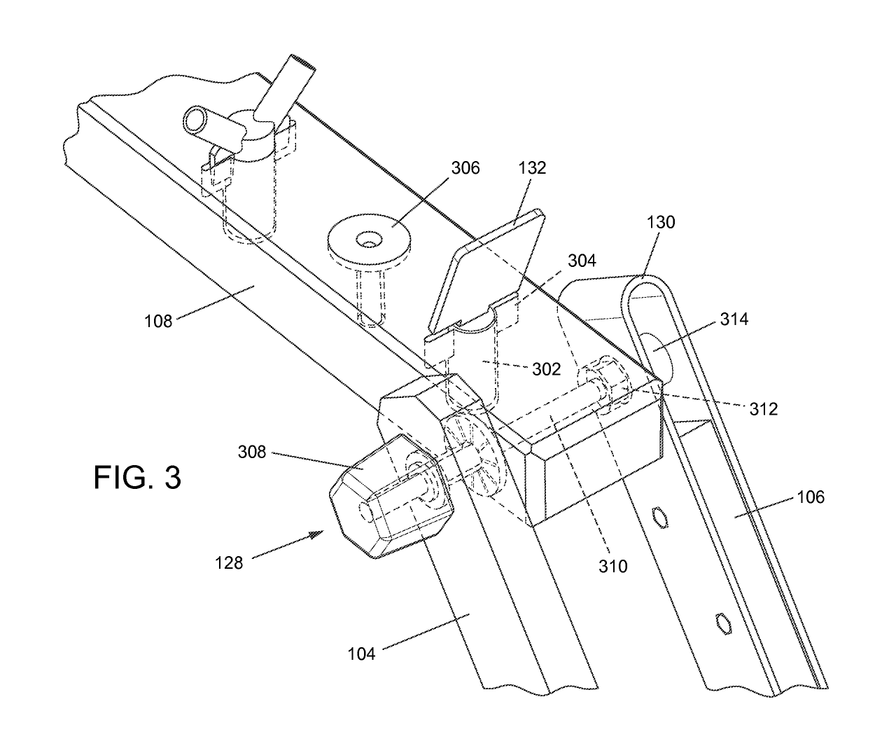

The car-flag adaptor 132 is shown in FIG. 3 to be inserted into a hole 302 similar to the hole 204. The hole 302 of the car-flag adaptor 132 also comprises slots 304, which act to prevent the adaptor 132 from rotating once inserted into the hole 302. Having a single hole design, for example holes 204,302, allows for versatility in placing the desired decorative items. However, in some embodiments, the horizontal beam 108 comprises a second type of holes, hole 306, which do not have the slots 206,304.

FIG. 3 also shows the internal mechanism of one embodiment of the tightener 128. As stated above, in some embodiments, the tighteners 128 and 124 operate similarly. In some embodiments, the tightener 128 comprises a tightening knob 308. In the illustrated embodiment, the knob 308 is housed on the angled beam 104. The skilled artisan knows that the arrangement of the tightener 128 can be reversed. The knob 308 is connected to a rod 310. The end of the rod 310 opposite to the knob 308 is threaded and is housed inside of the nut 312. The nut 312 is in turn attached to the angled beam 106, or if present, as is shown in FIG. 2, to the metal plate 130. In some embodiments, the nut 312 is located inside a hole on the side of the horizontal beam 108. The rod 310, in some embodiments, is a lag bolt, which has a square feature near the head, which prevents the rod 310 from turning when the knob 308 is turned. The metal plate 130 has a square cut-out on the opposite side to allow the rod 310 to be fed through the plate 130 and prevent it from turning.

When the knob 308 is turned to tighten the connection, the rod 310, which remains motionless, is threaded further into the knob 308, which brings the nut 312, and thereby the beam 106, closer to horizontal beam 108. This causes a friction lock to be created, which holds the relative placement of the beams 104, 106, and 108 in a stable position. When the knob 308 is loosened, beams 104 and 106 move apart, destroying the friction lock, thereby allowing free movement at the pivot point of the rod 310.

In some embodiments, a spacer 314 rests in the hollow created by the curvature of the metal plate 130 to provide support.

FIG. 1 shows the accessory 100 in its fully extended and open position. When not in use and for storage purposes, the accessory 100 can collapse on itself to minimize it volume. In one embodiment, the accessory 100 is removed from the brackets 110A and 110B and the tighteners 124A, 124B, 128A, and 128B are loosened and the platforms 116,118 are removed. The pivot point 128A is moved in line with the vertical beam 102A such that the pivot point 128A and point 112A are the opposite ends of the line created by the beams 102A and 104A,106A. The horizontal beam 108 is made to pivot around the point 128A, such that the pivot point 128B comes in close proximity to the point 112A. The vertical beam 102B and the angled beams 104B,106B are brought in a straight line and the whole line is swung in the opposite direction of the beam 108's motion, such that the point 112B is at the opposite end of the collapsed structure as the point 112A.

In some embodiments, the accessory 100 disclosed herein is configured to be attached to the bed of a pickup truck or to the roof of a car. This attachment allows for the display of an array of flags during a tailgate party.

In some embodiments, a bottle opener is attached to one of the beams of the accessory 100 for an easy and convenient access thereto.

What is claimed is:

1. A table accessory comprising:
a first vertical beam at a first end and a second vertical beam at a second end;
at least one first angled beam rotatably connected to the first vertical beam;
at least one second angled beam rotatably connected to the second vertical beam; and
a horizontal beam rotatably connected to both the first and the second angled beams.

2. The accessory of claim 1, further comprising a first bracket configured to receive the first vertical beam and a second bracket configured to receive the second vertical beam.

3. The accessory of claim 2, wherein the first and second brackets are configured to be affixed to a table.

4. The accessory of claim 2, wherein the first vertical beam is configured to be affixed to the first bracket and the second vertical beam is configured to be affixed to the second bracket.

5. The accessory of claim 1, further comprising a tightener at the point of connection between the first angled beam and the first vertical beam, wherein when the tightener is tightened, a friction lock is created thereby preventing the first angled beam to rotate with respect to the first vertical beam.

6. The accessory of claim 1, further comprising a tightener at the point of connection between the second angled beam and the second vertical beam, wherein when the tightener is tightened, a friction lock is created thereby preventing the second angled beam to rotate with respect to the second vertical beam.

7. The accessory of claim 1, further comprising a tightener at the point of connection between the first angled beam and the horizontal beam, wherein when the tightener is tightened, a friction lock is created thereby preventing the first angled beam to rotate with respect to the horizontal beam.

8. The accessory of claim 1, further comprising a tightener at the point of connection between the second angled beam and the horizontal beam, wherein when the tightener is tightened, a friction lock is created thereby preventing the second angled beam to rotate with respect to the horizontal beam.

9. The accessory of claim 1, having two first angled beams rotatably connected to the first vertical beam.

10. The accessory of claim 1, having two second angled beams rotatably connected to the second vertical beam.

11. The accessory of claim 1, wherein the horizontal beam comprises a plurality of holes to receive a flag holder each.

12. The accessory of claim 1, wherein the horizontal beam comprises at least one metal plate.

13. The accessory of claim 12, further comprising a storage unit magnetically attachable to the metal plate.
